(19) United States
(12) Patent Application Publication
(10) Pub. No.: US 2025/0297973 A1
(43) Pub. Date: Sep. 25, 2025

(54) Tool for Analysing the Chemical Composition and Structure of Nanolayers

(71) Applicant: IMEC VZW, Leuven (BE)

(72) Inventor: Esben Witting Larsen, Heverlee (BE)

(21) Appl. No.: 19/089,956

(22) Filed: Mar. 25, 2025

(30) Foreign Application Priority Data
Mar. 25, 2024 (EP) 24165987.9

(51) Int. Cl. G01N 23/201; G01N 23/20025; G01N 23/205

(52) U.S. Cl. CPC G01N 23/201; G01N 23/20025; G01N 23/205; G01N 2223/054; G01N 2223/1016

(57) ABSTRACT

An embodiment includes a method. The method includes mounting the sample in a sample holder. The sample holder is mounted on a first motorized table configured to rotate the sample so as to modulate the angle of incidence on a step-by-step basis within a given angular range. The method also includes positioning the sample in accordance with a first angle of incidence of a light beam produced by a light source, relative to the orientation of the layers. The method also includes positioning a spectrograph unit so that a camera is able to detect first order diffracted light originating from light reflected off the sample and propagating through the angle-sampling pipe in accordance with a predefined propagation direction. The method also includes recording, via the spectrograph unit, a spectral response determined by the detected first order diffracted light.

### CROSS-REFERENCE TO RELATED APPLICATIONS

The present application is a non-provisional patent application claiming priority to European Patent Application No. 24165987.9, filed Mar. 25, 2024, the contents of which are hereby incorporated by reference.

### TECHNICAL FIELD

The present disclosure is related to metrology tools for analysing nanoscaled layered 3D structures.

### BACKGROUND

Traditional electron-beam techniques for analysing nanostructured devices have limited chemical analytic capabilities. Thus, to further the device development, new characterization techniques with both high spatial resolution and element specificity are urgently needed for device development and characterization.

Light-based spectroscopy techniques are known to have molecular fingerprinting capabilities. One example is the use of the midinfrared (MIR, 2.5-10 μm) wavelength range for this purpose. However, due to the long wavelength of the MIR the spatial resolution of such techniques is limited to large areas. Also, MIR light exhibits large material penetration depths, and furthermore probes the delocalized valence electrons, thus local chemical environment is not easily accessible using MIR light.

X-ray absorption spectroscopy (XAS) provides the capability for both high spatial resolution and access to molecular fingerprinting with local information about neighbouring chemical structures, as it probes core level electrons. The chemical information is obtained by energy resolved XAS near atomic absorption resonances. When performed with soft X-rays it is traditionally called near edge X-ray absorption fine structure (NEXAFS), while it is called X-ray absorption near edge structure (XANES) when performed using hard X-rays. Document “Determination of optical constants of thin films in the EUV”, Ciesielski et al, Applied Optics Vol. 61, No. 8, 10 Mar. 2022 illustrates the applicability of wavelength-tuneable soft X-ray radiation delivered by a synchrotron for examining buried structures using grazing incidence soft X-ray scatterometry.

Nevertheless, the chemical sensitivity of these techniques is limited as synchrotron radiation is inherently monochromatic and the material chemical analysis must be conducted by repeating the same measurement for each individual wavelength. Also, although soft X-ray radiation is generally considered as providing non-destructive imaging, it does consist of ionization radiation. The repeated exposure required for the synchrotron-based approach can therefore potentially modify the chemical structure.

U.S. Patent Application Publication document US2021/239464 discloses a method for extending scatterometry measurements of periodic structures created on a substrate into the deep ultraviolet (UV) and soft X-ray regions of the electromagnetic spectrum. The method comprises measuring the scattering of a high harmonic generated (HHG) beam, which is created by a laser. The HHG beam is scattered from the structures on the substrate. The scattered HHG beam is measured by a spectrometer or a detector sensitive to EUV or X-ray radiation.

The publication “Novel compact spectrophotometer for EUV-optics characterization”, Starke et al, SPIE, vol. 6317, no. 631701 (2006-01-01) discloses a table-top spectrophotometer for measuring the spectral characteristics of extreme ultraviolet (EUV)-optics in the spectral range from 11 to 20 nm. The device is based on a polychromatic measurement principle using the direct irradiation of a compact EUV-tube for illuminating the sample and a broad-band spectrometer for detecting the probe and reference beam. The samples can be investigated under different angles of incidence and in respect to lateral dependencies. The spectrometer can be rotated around the sample as a function of the changing angle of incidence. Experimental results are limited to very specific sample types such as mirrors.

The setup of neither of the latter two cited documents is applicable for analysing more complex structured samples with stacked nanomaterials comprising multiple chemical elements where scattering and diffraction can occur at every interface, which for a broadband (continuum) light source would obfuscate the spectral response of the sample. The configuration described in US2021/239464 in particular needs the deployment of a well-calibrated reference sample to function. Furthermore, it necessitates the use of multiple diffraction orders fed into scatterometry algorithms to determine the properties of the examined samples.

### SUMMARY

The specification and drawings disclose embodiments that relate to a tool that does not suffer from the above drawbacks. The disclosure is therefore related to a metrology tool and to a method as disclosed in the appended claims.

In a first aspect, the disclosure describes a metrology tool suitable for placing therein a sample. The sample includes one or more nanosized layers. The metrology tool includes a light source configured to produce a light beam and a vacuum chamber configured to receive the light beam. The vacuum chamber includes a sample holder for mounting the sample thereon such that that the light beam impinges on the sample at an angle of incidence relative to the orientation of the nanosized layers of the sample. The sample holder is itself mounted on a first motorized table configured to rotate the sample so as to modulate the angle of incidence on a step-by-step basis within a given angular range. The vacuum chamber also includes a spectrograph unit. The spectrograph unit includes a reflective diffraction grating, an angle-sampling pipe for allowing only reflected light propagating in a predefined propagation direction to impinge on the diffraction grating, and a camera for detecting the intensity of light diffracted by the grating as a function of the wavelengths within said range. The spectrograph unit is mounted on a second motorized table configured to rotate the unit around the sample and independently thereof, so that by rotating the spectrograph unit, the orientation of the diffraction grating relative to said predefined propagation direction of the reflected light can be kept constant for each angle of incidence

In a second aspect, the disclosure describes a method for analyzing a material sample comprising a base substrate and one or more nanosized layers on the base substrate. The method includes mounting the sample in a sample holder. The sample holder is mounted on a first motorized table configured to rotate the sample so as to modulate the angle of incidence on a step-by-step basis within a given angular range. The method also includes positioning the sample in accordance with a first angle of incidence of a light beam produced by a light source, relative to the orientation of the layers. The method also includes positioning a spectrograph unit so that a camera is able to detect first order diffracted light originating from light reflected off the sample and propagating through the angle-sampling pipe in accordance with a predefined propagation direction. The method also includes recording, via the spectrograph unit, a spectral response determined by the detected first order diffracted light.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a top-down view of a metrology tool in accordance with example embodiments.

FIGS. 2 and 3 are detail images of a light beam impinging on a sample mounted in the metrology tool shown in FIG. 1, in accordance with example embodiments.

FIG. 4 illustrates another embodiment of a metrology tool with an additional photodiode, in accordance with example embodiments.

FIG. 5 shows both the top-down view and a side view of the sample holder and the first motorized table in the metrology tool of FIG. 1, in accordance with example embodiments.

FIGS. 6 and 7 illustrate the metrology tool of FIG. 1 wherein the sample has been rotated relative to the position shown in FIG. 1, in accordance with example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

### II. Example Metrology Tools

The following description and accompanying drawings will elucidate features of various example embodiments. The embodiments provided are by way of example, and are not intended to be limiting. As such, the dimensions of the drawings are not necessarily to scale.

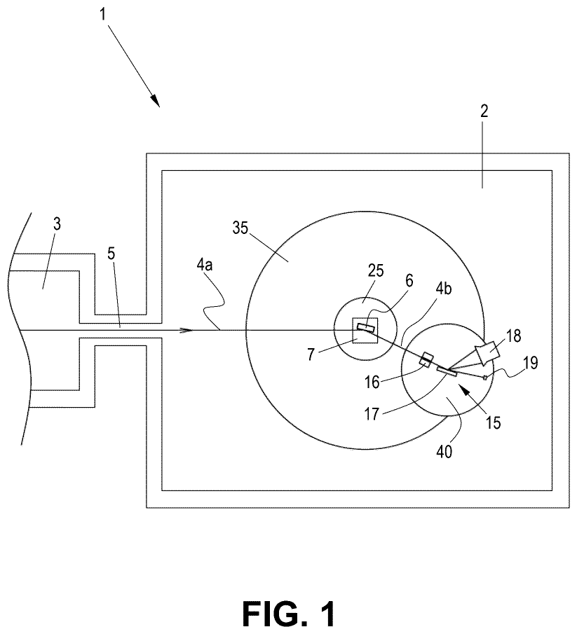

Referring to the top-down view shown in FIG. 1 of a metrology tool 1 according to an example embodiment, the tool may include a vacuum chamber 2 and a light source 3 configured to produce a broadband light beam 4a in the soft X-ray range or in the extreme ultraviolet (EUV) range, and introduce the beam into the vacuum chamber 2 through an aperture 5 in one of the chamber walls. In some embodiments, the light source 3 may be a laser-based HHG (high harmonic generation) source. With “broadband beam” is meant a beam containing a continuous range of wavelengths k, hence a continuous range of photon energies expressed in electron volts (eV) and related to the wavelengths by the relation E=hc/λ (with h equal to Planck's constant and c equal to the speed of light).

In some embodiments, a 2.3 μm laser based on optical parametric chirped pulse amplification can be deployed to make soft X-ray light in the 200-600 eV range, while a 1 m laser can deliver 60-200 eV photons.

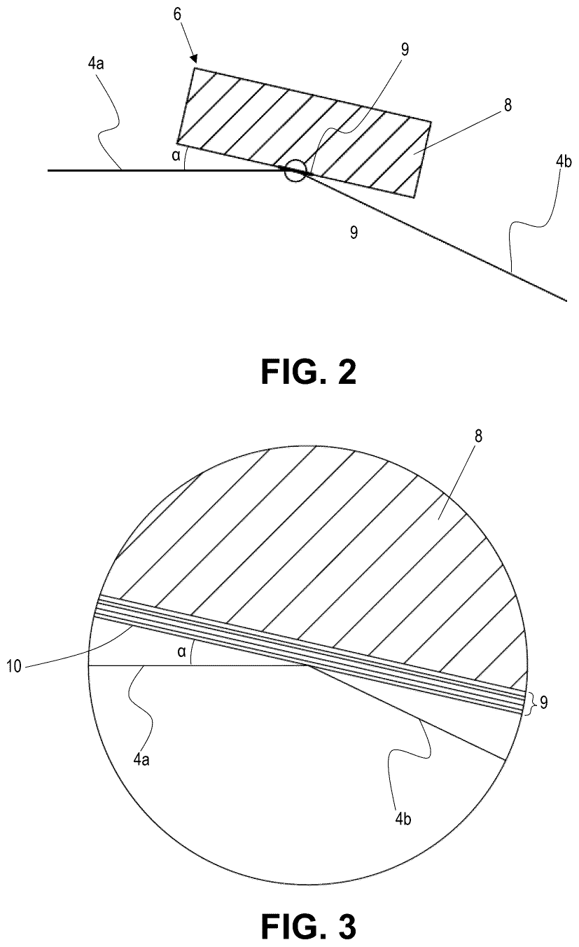

As shown in FIG. 1, the light beam 4a impinges on a sample 6 mounted on a sample holder 7 placed in the vacuum chamber 2. The detail images in FIGS. 2 and 3 illustrate vertical cross-section views of the sample 6, showing that the sample 6 includes a base substrate 8 and a stack of nanosized layers 9 on the base substrate. FIG. 3 depicts a magnified view of the circled region in FIG. 2. With “nanosized layers” is meant layers having a thickness in the range of a few nanometres up to a few tens of nanometres, for example the thickness of the layers 9 may be between 5 nm and 50 nm, or between 5 nm and 20 nm. The top layer defines the upper planar surface 10 of the sample. The beam 4a propagates along a propagation direction and impinges on the upper planar surface 10. In the condition shown in FIGS. 1 to 3, the sample 6 is oriented relative to the beam 4a so that the beam 4a impinges on said upper planar surface 10 at an angle of incidence a of about 23°. The light is focused onto the sample 6 to maximize the spatial resolution. The light is polarized according to a given polarization direction perpendicular to the propagation direction of the beam 4a. Light is reflected off the sample, as visualized by the reflected beam 4b. Depending on the structure of the sample surface, the reflected light may be scattered to some degree.

Referring again to FIG. 1, the tool 1 further includes a spectrograph unit 15 including a number of components, including an angle-sampling pipe 16 and a reflective diffraction grating 17. The angle-sampling pipe 16 may be configured to allow only reflected light propagating in a specific direction to fall onto the diffraction grating 17.

In particular, the angle sampling pipe enables allowing only the 0-order light diffraction of a sample. This is also known as the specular reflection. This cannot be done when the spectrograph comprises an entrance slit. When a spectrometer with a simple entrance slit is utilized on a broadband or wavelength continuum light source the spectral response can be obfuscated or blurred as the slit will define the entrance point of the spectrometer. In contrast, by utilizing an angular sampling pipe instead of a simple slit the angular acceptance of the spectrograph unit is heavily reduced without changing the source plane, and it ensures that the incidence angle onto the grating is not changed. Thus, the angular sampling pipe 16 may be utilized in reflectometry mode, where only the specular reflection is measured.

The angle sampling pipe may be a cylindrical pipe with a circular cross-section or a conical pipe with a circular cross-section. Within the present context, a pair of parallel plates may also be regarded as an angle sampling pipe.

The grating 17 diffracts the light impinging on it in different directions for the respective diffraction orders 0, 1, 2, etc. The first order diffracted light is captured by a camera 18 configured to detect and measure the light intensity as a function of the photon energies contained in the 1st order diffracted light signal (hereafter referred to as the “spectral response”). These photon energies are the same as the energies contained in the original impinging light beam 4a. Due to interaction between the original beam 4a and the sample 6, the intensity of the reflected light is modulated, showing for example a peak in the spectral response at a particular photon energy, indicating the presence of a particular material. The strength and/or shape of the peak can be used to determine structural characteristics of the detected materials, such as the thickness of the nanolayers 9. In some embodiments, the grating may be a variable-line-space X-ray grating. The EUV/soft X-ray camera 18 may be an in-vacuum camera, for example a CMOS camera or a CCD camera. In the embodiment shown in FIG. 1, the spectrograph unit 15 includes a photodiode 19 positioned to detect the 0-order diffracted light (diffracted from the grating 17). This measurement can be used to monitor instabilities in power of the incident beam 4a. The photodiode 19 may not be included in some embodiments.

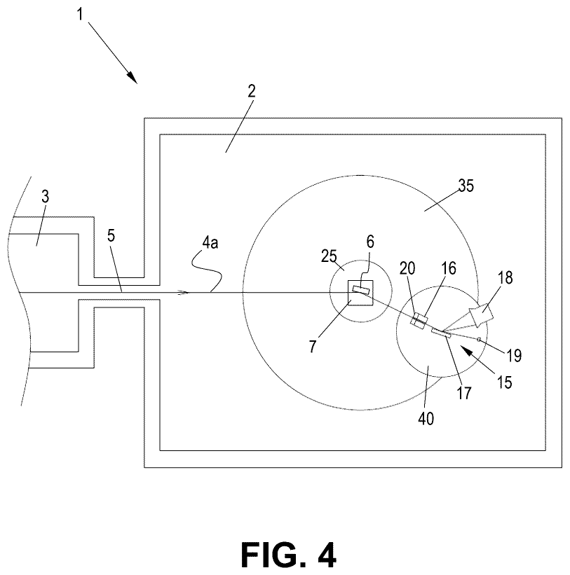

According to another embodiment, the spectrograph unit 15 includes a photodiode positioned at the entrance of the sampling pipe 16. This diode can measure the incoming light intensity. By comparing the intensities measured by the diode at the entrance of the sampling pipe with the intensity measured by the camera 18 and the diode 19, the grating efficiency of the 0-order and 1-order diffraction can be evaluated. According to the embodiment shown in FIG. 4, the diode 20 at the entrance of the sampling pipe is a four-quadrant diode, which includes four distinct quadrant parts and a central opening for admitting the 0-order diffracted beam. The quadrant photodiode enables fast readout of beam pointing by comparing the readout signals from the four different quadrants. The readout can be faster with the diode than with the EUV camera 18, thereby enabling in-situ measurements of beam-drifts during measurements, i.e., both pointing and power drifts. Other types of diodes may be used as the diode 20 in other embodiments.

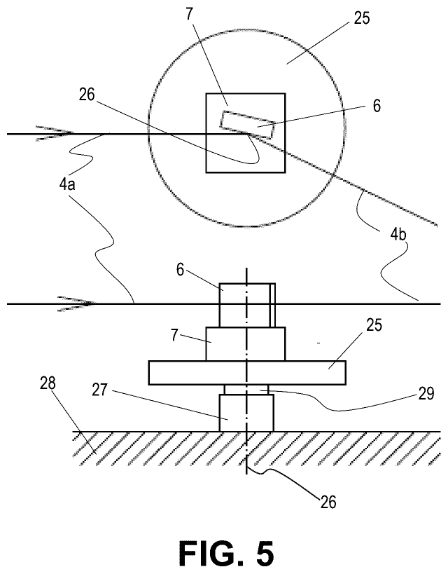

As illustrated in FIG. 5, the sample 6 is mounted on a sample holder 7 that is itself mounted on a motorized rotation table 25 configured to rotate about a central rotation axis 26. The sample holder 7 is shown by way of example as a block onto which the sample 6 is placed. However, this may be any holder suitable for holding a sample of typical dimensions applicable in NEXAFS or similar analysis techniques. The sample holder 7 may include position adjustment means for accurately positioning the sample relative to the propagation direction and the polarization direction of the incoming light beam 4a and relative to the rotation table 25.

The sample is positioned as shown in the drawing, i.e. with the central rotation axis 26 of the table 25 intersecting the impingement area of the beam 4a, so that the beam impinges on the same point of the sample regardless of the angular position of the rotation table 25. The measurement can be repeated for a plurality of impingement areas on the sample 6.

The rotation table 25 may be motorized, meaning that the table may be coupled to a motor 27 for rotating the table about the central axis 26. In FIG. 5, the motor is schematically represented as a block 27 mounted on a chassis 28 that is fixed to the vacuum chamber 2, with the table 25 fixed to the output axle 29 of the motor, but any equivalent motorized configuration is possible in other embodiments, for example including a motor that is not coaxial with the table 25 and coupled thereto by a suitable transmission. For instance, the motor 27 may be an electrical motor coupled to a control unit configured to control the angular position of the table 25. The control unit may be physically present outside the vacuum chamber 2, and coupled to the motor 27 by a wired or wireless connection.

The control unit may be configured to enable positioning the table 25 and thereby the sample 6 at a plurality of angular positions within a given angular range, with a well-defined angular spacing of for example 1° between consecutive angular positions. In this way, the angle of incidence a of the light beam 4a onto the sample 6 can be changed on a step-by-step basis.

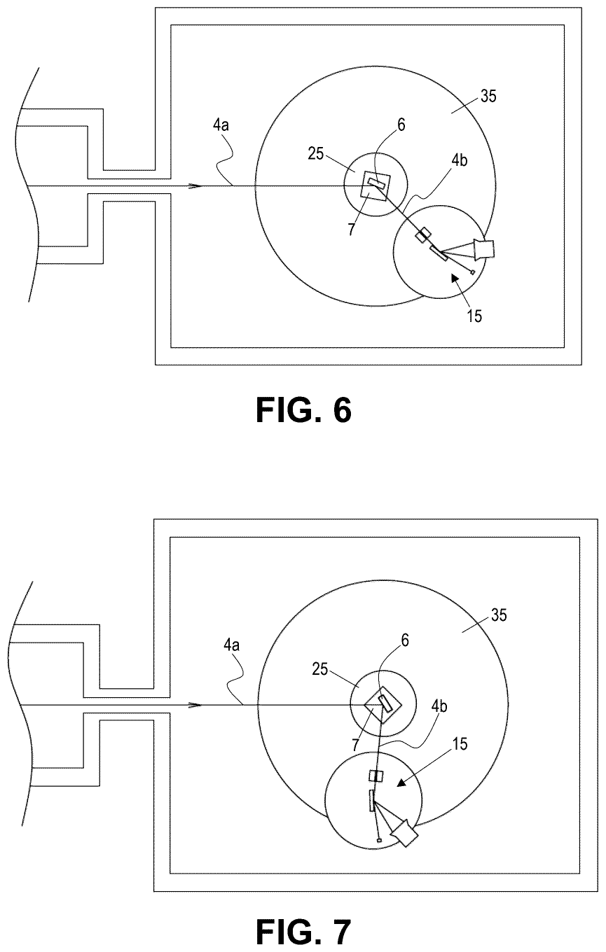

In order to measure comparable responses for a plurality of angles of incidence a, the spectrograph unit 15 may be mounted on a second motorized table 35 configured to rotate about the central rotation axis 26 of the first table 25, as shown in FIGS. 6 and 7. In the embodiment shown, the second table 35 is a disc arranged coaxially with respect to the first table 25. The rotation of the disc 35 could be motorized by a motor and a suitable transmission but any equivalent arrangement is possible. The spectrograph unit 15 could for example be mounted on a table that is movable by a suitable motor on a circular rail arranged around the sample holder 7.

Obtaining comparable responses means that the light admitted through the angle sampling pipe 16 must fall onto the diffraction grating 17 at the same angle of incidence relative to said grating for every angular position of the sample 6. In order to achieve this, the spectrograph unit 15 as a whole may be rotated about the axis 26 by controlling the rotation of the second motorized table 35. When the sample is rotated about axis 26 by a given angular value, the spectrograph unit 15 must be rotated by twice this value in order to maintain the same orientation of the diffraction grating 17 relative to the light reflected off the sample 6. This is illustrated in FIGS. 6 and 7, showing the position of the spectrograph unit 15 when the sample is rotated over 100 and 450 respectively, with respect to the position shown in FIG. 1.

The tool 1 thereby enables obtaining a 2D-map showing the recorded spectral responses measured by the camera 18 for a plurality of incidence angles α, for example for 91 values of said angle: α=0°, 1°, 2°, . . . 90°. In such a 2D map, the recorded responses are juxtaposed as a function of the applied angles of incidence The tool described herein enables recording the response simultaneously for a full range of photon energies, whereas other approaches require applying different photon energies on a step-by-step basis for each angle of incidence. The approach enabled by the present disclosure is therefore faster and less intrusive in terms of potential damage to the sample due to long term exposure to ionization radiation.

Instead of a laser-based HHG source, other types of light sources for producing broadband light in the soft X-ray or extreme UV range may be applied in a tool according to the disclosure, including plasma sources or the so-called ‘pink beam’ obtained from bending magnets in a synchrotron.

Using any of the abovenamed light sources, the tool 1 can be used to determine spectral responses by averaging the signals acquired by the camera 18 over a given integration time.

In the embodiment shown, the spectrograph unit 15 is represented as an assembly of components or system including an angle sampling pipe, grating, camera, and diode which are mounted in a fixed relation to each other on a circular disc 40. Between measurements performed at different angles of incidence of the light beam 4a on the sample 6, i.e. at different angular positions of the first and second motorized tables 25 and 35, the orientation of the disc 40 remains fixed relative to the second motorized table 35. According to a preferred embodiment however, the disc 40 is rotatable about its central axis relative to the second table 35, in order to be able to set the angular position of the grating 17 prior to starting said measurements at different angles of incidence.

### II. Enumerated Example Embodiments

Embodiments of the present disclosure may thus relate to one of the enumerated example embodiments (EEEs) listed below.

EEE 1 is a metrology tool suitable for placing therein a sample comprising one or more nanosized layers, the tool comprising:
a light source configured to produce a light beam; and
a vacuum chamber configured to receive the light beam, wherein the vacuum chamber comprises:
   a sample holder for mounting the sample thereon such that that the light beam impinges on the sample at an angle of incidence relative to the orientation of the nanosized layers of the sample, wherein the sample holder is itself mounted on a first motorized table configured to rotate the sample so as to modulate the angle of incidence on a step-by-step basis within a given angular range; and a spectrograph unit comprising:
   a reflective diffraction grating,
   an angle-sampling pipe for allowing only reflected light propagating in a predefined propagation direction to impinge on the diffraction grating, and
   a camera for detecting the intensity of light diffracted by the grating as a function of the wavelengths within said range, wherein the spectrograph unit is mounted on a second motorized table configured to rotate the unit around the sample and independently thereof, so that by rotating the spectrograph unit, the orientation of the diffraction grating relative to said predefined propagation direction of the reflected light can be kept constant for each angle of incidence.

EEE 2 is the tool according to EEE 1, wherein the light source is a laser-based High Harmonic Generation source.

EEE 3 is the tool according to EEE 1, wherein the light source is a plasma source.

EEE 4 is the tool according to EEE 1, wherein the light source is configured to produce the light beam in a soft X-ray or extreme ultraviolet range.

EEE 5 is the tool according to claim 1, wherein the spectrograph unit further comprises a photodiode arranged for detecting the 0-order of light diffracted by the diffraction grating.

EEE 6 is the tool according to claim 1, wherein the spectrograph unit further comprises a photodiode at the entrance to the angle sampling pipe.

EEE 7 is the tool according to EEE 6, wherein the photodiode at the entrance to the angle sampling pipe is a four-quadrant photodiode comprising four distinct quadrants and a central opening.

EEE 8 is the tool according to EEE 1, wherein the light source is a broadband source producing light in a range of 200-600 eV or in a range of 60-200 eV.

EEE 9 is the tool according to EEE 1, wherein the angle sampling pipe is a cylindrical pipe or a conical pipe or a pair of parallel plates.

EEE 10 is the tool according to EEE 1, wherein the reflective diffraction grating comprises variable-line-space X-ray grating.

EEE 11 is a method for analyzing a material sample comprising a base substrate and one or more nanosized layers on the base substrate, the method comprising:
mounting the sample in a sample holder, wherein the sample holder is mounted on a first motorized table configured to rotate the sample so as to modulate the angle of incidence on a step-by-step basis within a given angular range,
positioning the sample in accordance with a first angle of incidence of a light beam produced by a light source, relative to the orientation of the layers,
positioning a spectrograph unit so that a camera is able to detect first order diffracted light originating from light reflected off the sample and propagating through the angle-sampling pipe in accordance with a predefined propagation direction, and
recording, via the spectrograph unit, a spectral response determined by the detected first order diffracted light.

EEE 12 is the method according to EEE 11, further comprising:
by stepwise rotation of the first motorized table, rotating the sample step by step in accordance with a plurality of angles of incidence within a given angular range,
at each angle of incidence, and by a respective stepwise rotation of a second motorized table, rotating the spectrograph unit so as to maintain a constant orientation of the diffraction grating relative to the predefined propagation direction of the light reflected off the sample, and
at each angle of incidence, recording via the spectrograph unit respective spectral responses determined by the detected first order diffracted light.

EEE 13 is the method according to EEE 12, further comprising:
composing a 2-dimensional map of the recorded responses by juxtaposing the acquired spectral responses as a function of the applied angles of incidence, and
deriving from said map data relative to the composition and structure of the one or more nanosized layers.

EEE 14 is the method according to EEE 11, wherein the predefined propagation direction is the propagation direction of the 0-order diffraction of light impinging on the sample.

EEE 15 is the method according to EEE 11, wherein the light source is configured to produce the light beam in a soft X-ray or extreme ultraviolet range.

EEE 16 is the method according to EEE 11, wherein the light source is a broadband source producing light in a range of 200-600 eV or in a range of 60-200 eV.

EEE 17 is the method according to EEE 11, wherein the spectrograph unit further comprises a photodiode arranged for detecting the 0-order of light diffracted by the diffraction grating.

EEE 18 is the method according to EEE 11, wherein the spectrograph unit further comprises a photodiode at the entrance to the angle sampling pipe.

EEE 19 is the method according to EEE 11, wherein the sample holder and spectrograph unit are disposed within a vacuum chamber.

EEE 20 is the method according to EEE 19, wherein the camera is an in-vacuum CMOS or CCD camera

### III. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like ROM, optical or magnetic disks, solid state drives, compact-disc read only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A metrology tool suitable for placing therein a sample comprising one or more nanosized layers, the tool comprising:
a light source configured to produce a light beam; and
a vacuum chamber configured to receive the light beam, wherein the vacuum chamber comprises:
a sample holder for mounting the sample thereon such that that the light beam impinges on the sample at an angle of incidence relative to the orientation of the nanosized layers of the sample, wherein the sample holder is itself mounted on a first motorized table configured to rotate the sample so as to modulate the angle of incidence on a step-by-step basis within a given angular range; and
a spectrograph unit comprising:
a reflective diffraction grating,
an angle-sampling pipe for allowing only reflected light propagating in a predefined propagation direction to impinge on the diffraction grating, and
a camera for detecting the intensity of light diffracted by the grating as a function of the wavelengths within said range, wherein the spectrograph unit is mounted on a second motorized table configured to rotate the unit around the sample and independently thereof, so that by rotating the spectrograph unit, the orientation of the diffraction grating relative to said predefined propagation direction of the reflected light can be kept constant for each angle of incidence.

2. The tool according to claim 1, wherein the light source is a laser-based High Harmonic Generation source.

3. The tool according to claim 1, wherein the light source is a plasma source.

4. The tool according to claim 1, wherein the light source is configured to produce the light beam in a soft X-ray or extreme ultraviolet range.

5. The tool according to claim 1, wherein the spectrograph unit further comprises a photodiode arranged for detecting the 0-order of light diffracted by the diffraction grating.

6. The tool according to claim 1, wherein the spectrograph unit further comprises a photodiode at the entrance to the angle sampling pipe.

7. The tool according to claim 6, wherein the photodiode at the entrance to the angle sampling pipe is a four-quadrant photodiode comprising four distinct quadrants and a central opening.

8. The tool according to claim 1, wherein the light source is a broadband source producing light in a range of 200-600 eV or in a range of 60-200 eV.

9. The tool according to claim 1, wherein the angle sampling pipe is a cylindrical pipe or a conical pipe or a pair of parallel plates.

10. The tool according to claim 1, wherein the reflective diffraction grating comprises variable-line-space X-ray grating.

11. A method for analyzing a material sample comprising a base substrate and one or more nanosized layers on the base substrate, the method comprising:
mounting the sample in a sample holder, wherein the sample holder is mounted on a first motorized table configured to rotate the sample so as to modulate the angle of incidence on a step-by-step basis within a given angular range,
positioning the sample in accordance with a first angle of incidence of a light beam produced by a light source, relative to the orientation of the layers,
positioning a spectrograph unit so that a camera is able to detect first order diffracted light originating from light reflected off the sample and propagating through the angle-sampling pipe in accordance with a predefined propagation direction, and
recording, via the spectrograph unit, a spectral response determined by the detected first order diffracted light.

12. The method according to claim 11, further comprising:
by stepwise rotation of the first motorized table, rotating the sample step by step in accordance with a plurality of angles of incidence within a given angular range,
at each angle of incidence, and by a respective stepwise rotation of a second motorized table, rotating the spectrograph unit so as to maintain a constant orientation of the diffraction grating relative to the predefined propagation direction of the light reflected off the sample, and
at each angle of incidence, recording via the spectrograph unit respective spectral responses determined by the detected first order diffracted light.

13. The method according to claim 12, further comprising:
composing a 2-dimensional map of the recorded responses by juxtaposing the acquired spectral responses as a function of the applied angles of incidence, and
deriving from said map data relative to the composition and structure of the one or more nanosized layers.

14. The method according to claim 11, wherein the predefined propagation direction is the propagation direction of the 0-order diffraction of light impinging on the sample.

15. The method according to claim 11, wherein the light source is configured to produce the light beam in a soft X-ray or extreme ultraviolet range.

16. The method according to claim 11, wherein the light source is a broadband source producing light in a range of 200-600 eV or in a range of 60-200 eV.

17. The method according to claim 11, wherein the spectrograph unit further comprises a photodiode arranged for detecting the 0-order of light diffracted by the diffraction grating.

18. The method according to claim 11, wherein the spectrograph unit further comprises a photodiode at the entrance to the angle sampling pipe.

19. The method according to claim 11, wherein the sample holder and spectrograph unit are disposed within a vacuum chamber.

20. The method according to claim 19, wherein the camera is an in-vacuum CMOS or CCD camera.
